(19) United States
(12) Patent Application Publication
(10) Pub. No.: US 2006/0237868 A1
(43) Pub. Date: Oct. 26, 2006

(54) Method and device for manufacturing card

(75) Inventor: Kaori Ito, Chiba (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO PRECISION INC., Marashino-shi (JP)

(21) Appl. No.: 10/567,730

(22) PCT Filed: Aug. 11, 2004
(86) PCT No.: PCT/JP04/11548

§ 371 Date: Feb. 10, 2006

(30) Foreign Application Priority Data
Aug. 13, 2003 (JP) 2003-292828

(51) Int. Cl. B29C 45/14

(52) U.S. Cl. 264/132; 264/255; 264/259; 425/129.1

(57) ABSTRACT

The present invention provides a method and a device for manufacturing a card, capable of arbitrarily printing characters and designs on an ink receiving layer after molding the card by injection molding. The card is manufactured by joining an ink receiving layer (2) formed on a base material sheet (4a) to a card base (1) when molding the card base (1) by filling an injection-molding resin (10) in a cavity (7) of a metal mold (5), and after this by peeling the base material sheet (4a). A desired printing is applied to the card on its ink receiving layer (2) by an ink-jet printer or the like after the card is taken out from the metal mold (5).

### TECHNICAL FIELD

The present invention relates to a method and a device for manufacturing a card to be used for personal identification, etc., wherein a desired printing will be applied to the card after the card base is manufactured.

### BACKGROUND ART

Various cards are now used, including magnetic cards such as cash cards, etc., and identification cards for personal identification, etc. The card base of these cards is usually made of plastic material. Some plastic cards are manufactured in a mass with the same design on their surface. On the other hand, there are cards that are manufactured in a small lot with a great variety, having on their surface printings of characters (for example, name, etc.) and designs (for example, facial portrait, etc.) that are different card by card. The characters and designs to be printed are printed on the card surface with the use of a compact thermal dye sublimation printer or thermal transfer printer.

Recently, ink-jet printers have been spread that can save the running costs lower than the thermal dye sublimation printer or the thermal transfer printer. For example, Patent Document 1 discloses a method for manufacturing a card by printing characters and designs on an ink receiving layer with the use of an ink-jet printer, and then adhering the ink receiving layer to a molding resin. To be more specific, as shown in FIG. 8, according to this card manufacturing method, a peel layer 12 and an ink receiving layer 13 are formed on a base material sheet 11, characters and designs are printed on the ink receiving layer 13 by an ink-jet printer, and an adhesive layer 14 is formed on the printed ink receiving layer 13, whereby a transfer sheet is formed. After this, the transfer sheet is inserted into a cavity 17 of a metal mold 15 in the state where the adhesive layer 14 faces a mold gate 16 of the metal mold 15, and resin is injected into the cavity 17 through the mold gate 16 to join the decorated transfer sheet to the molding resin by injection molding.

Patent Document 1: Unexamined Japanese Patent Application KOKAI Publication No. H11-28856.

### DISCLOSURE OF INVENTION

### Problem to be Solved by the Invention

According to the card manufacturing method of the prior art, characters and designs are printed on the ink receiving layer before injection molding, and characters and designs cannot arbitrarily be printed on the ink receiving layer after the molding material is injection-molded.

Hence, the object of the present invention lies in providing a card manufacturing method and device capable of arbitrarily printing characters and designs on the ink receiving layer after the card is molded.

### Means for Solving the Problem

A method for manufacturing a card according to the present invention comprises: a step of inserting a transfer sheet constituted by a base material sheet on which an ink receiving layer is formed into a cavity of a metal mold in a state where a surface of the ink receiving layer faces a mold gate of the metal mold; a step of molding a card base by injecting an injection-molding resin into the cavity in a state where the transfer sheet is disposed in the cavity, and at the same time joining the ink receiving layer to the card base; a step of taking out the card base joined by the ink receiving layer from the cavity; and a step of peeling the base material sheet from the transfer sheet in a manner that the ink receiving layer is left on the card base.

A card manufacturing device according to the present invention comprises: a transfer sheet supply section which carries a transfer sheet constituted by a base material sheet on which an ink receiving layer is formed; and a molding section which has a cavity into which the ink receiving layer is inserted toward its bottom surface via the base material sheet and a mold gate from which an injection-molding resin is injected into the cavity, and which molds a card base on the ink receiving layer of the transfer sheet carried from the transfer sheet supply section, whereby a card formed of the card base integrated with the ink receiving layer is manufactured.

### Effects of the Invention

According to the present invention, it is possible to arbitrarily print characters and designs on an ink receiving layer serving as a print surface, after molding a card by injection molding. Accordingly, the flexibility in card printing is greatly improved.

### BRIEF DESCRIPTION OF DRAWINGS

FIGS. 1(a) to (d) are cross sectional views of a metal mold for explaining one embodiment of the card manufacturing method of the present invention;

FIG. 2 is a partial cross sectional view of the card of the present invention on which printing are applied;

FIG. 3 is an explanatory diagram when printings are applied to an ink receiving layer by using an ink-jet printer;

FIG. 4 shows a card covered with a cover layer;

FIG. 5(a) is a cross sectional view of a transfer sheet where an anchor layer is formed on an ink receiving layer, and FIG. 5(b) is a partial cross sectional view of another card of the present invention manufactured by using the transfer sheet shown in FIG. 5(a);

FIG. 6 is an explanatory diagram for explaining one embodiment of the card manufacturing device of the present invention, and shows a state when the ink receiving layer of the transfer sheet is carried to a metal mold, where the metal mold is the same as in FIG. 1(a);

FIG. 7 is a flowchart for explaining one embodiment of the card manufacturing device of the present invention; and

FIG. 8 is a cross sectional view of a transfer sheet and metal mold for explaining one example of conventional card manufacturing.

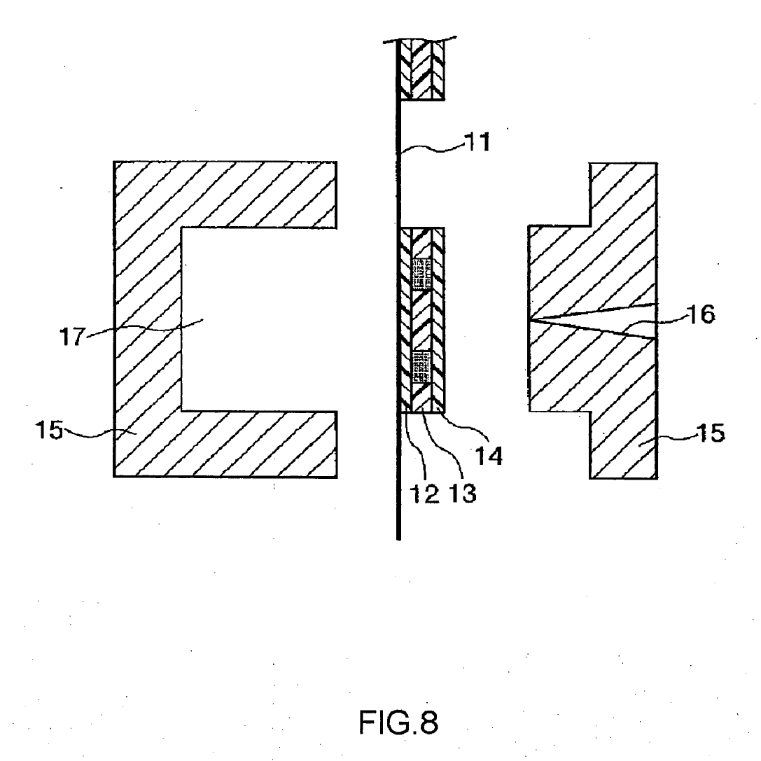

### EXPLANATION OF REFERENCE NUMERALS

1 card base

2 ink receiving layer

3 ink

4 transfer sheet

4a base material sheet

5 metal mold

5a,5b molds

6 mold gate

7 cavity

8 anchor layer

9 cover layer

10 injection-molding resin

21 ink-jet printer

40 peeling section (robot)

51 card manufacturing device

53 transfer sheet supply section

55 molding section

59 control section

61 printer

63 laminating device

### BEST MODE FOR CARRYING OUT THE INVENTION

The present invention will now be specifically described.

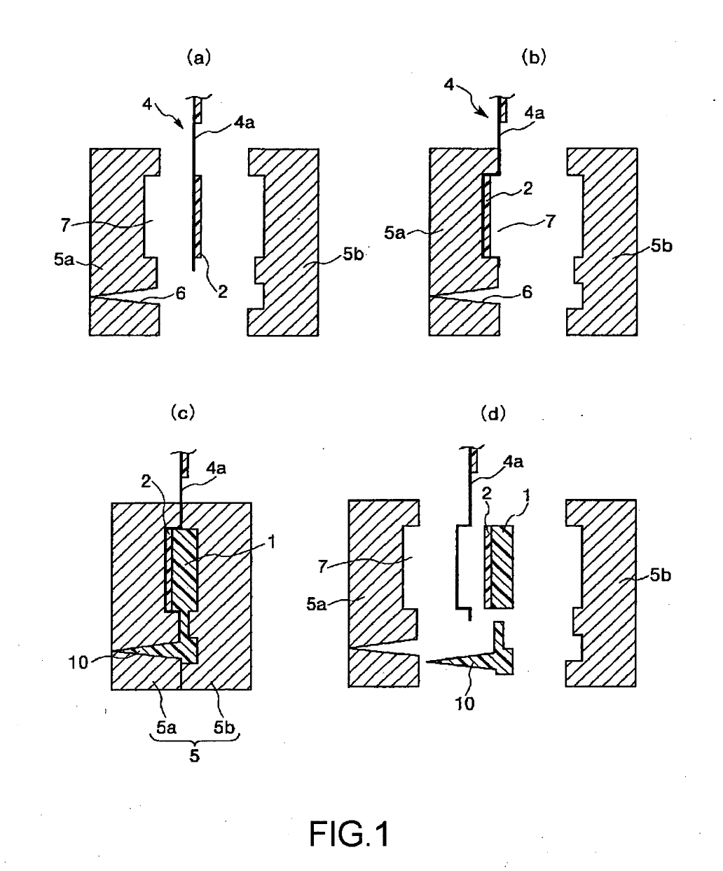

First, a card manufacturing method according to one embodiment of the present invention will be specifically described with reference to FIG. 1.

As shown in FIG. 1(a), from a supply source (for example, a roll) of a transfer sheet 4 which is constituted by a base material sheet 4a on which an ink receiving layer 2 is formed, the end portion of the transfer sheet 4 is supplied to an opened metal mold (molds 5a and 5b) 5. Then, the ink receiving layer 2 is inserted into a cavity 7. As shown in FIG. 1(b), the transfer sheet 4 is inserted into the cavity 7 of the mold 5a in a manner that the base material sheet 4a contacts the internal surface of the cavity 7 of the mold 5a and room is left above the surface of the ink receiving layer 2.

The base material sheet 4a is formed of a film made of polyethylene terephthalate (PET), polycarbonate (PC), or the like. The ink receiving layer 2 is preferably formed of a heat-curable hydrophilic resin such as heat-curable acrylic resin, urethane resin, etc. The transfer sheet 4 is formed by coating the paste of the heat-curable hydrophilic resin on the base material sheet 4a slightly more widely than the aperture area of the cavity 7 with the use of a coating machine or the like, and then heating and drying the resin paste.

The ink receiving layer 2 is required to adequately absorb ink and fix it thereon. The ink receiving layer 2 might reject printing on the card surface by aqueous ink (cannot fix aqueous ink), depending on the resins to form the ink receiving layer 2. However, if being formed of a heat-curable hydrophilic resin, the ink receiving layer 2 can allow printing on the card surface by aqueous ink (can fix aqueous ink). The material of the ink receiving layer 2 is not limited to heat-curable hydrophilic resin. For example, room-temperature-curable hydrophilic resin that is curable by air seasoning after it is coated may be used.

A pigment may be mixed into the hydrophilic resin that forms the ink receiving layer 2. Silica, diatom earth, calcium carbonate, alumina, aluminum hydroxide, etc. are given as suitable pigment. Further, various additives such as ultraviolet absorber, antioxidant, pH adjuster, surfactant, waterproofness booster, etc. are used together with the pigment in accordance with necessity.

Then, as shown in FIG. 1(c), the metal mold 5 is closed in the state where the transfer sheet 4 is disposed in the cavity 7. After this, an injection-molding resin 10 is injected into the room in the cavity 7 from a mold gate 6 through a resin supply duct in order to mold a card base 1. When being molded, the card base 1 is joined by the ink receiving layer 2, and the card base 1 is thereby fusion-bonded to the transfer sheet 4. The injection-molding resin 10 that forms the card base 1 is preferably, for example, acrylonitrile-butadiene-styrene copolymer (ABS). The injection-molding resin 10 is not restrictive as long as it is of plastic material that is injection-moldable, such as polyvinyl chloride (PVC), PC, etc. Further, in a case where the card to be manufactured is a magnetic card, magnetic powder of iron oxide, nickel, or the like is mixed in the injection-molding resin 10.

Further, as shown in FIG. 1(d), the metal mold 5 is opened after the card base 1 is molded to take out the card base 1 from the cavity 7. At this time, the base material sheet 4a between the joined ink receiving layer 2 and its succeeding un-joined ink receiving layer 2 is cut by a cutter, a knife, or the like in the across-the-width direction. At the same time of cutting the base material sheet 4a or before or after the cutting, a sprue formed in the mold gate 6 and resin supply duct is cut and removed. The sprue is removed by cutting the base material sheet 4a in the across-the-width direction by a cutter or the like along one side of the card base 1 on which the sprue is formed. When the base material sheet 4a is peeled from the card base 1 joined by the ink receiving layer 2, a card constituted by the ink receiving layer 2 and card base 1 integrated with each other is manufactured. The cutting of the base material sheet 4a, the peeling of the base material sheet 4a, and the cutting of the sprue may be carried out in an arbitrary order.

The metal mold 5 shown in FIG. 1 comprises cut-in-half molds 5a and 5b. The cavity 7 having a plane corresponding to the card base 1 and ink receiving layer 2 is recessed into the internal surface of one or both of the molds 5a and 5b, and the mold gate 6 is formed in the one mold 5a. Though only one cavity 7 is shown in the metal mold 5 shown in FIG. 1, normally, plural columns and plural rows of cavities 7 are formed in a matrix state.

Preferably, the interior of the cavity 7 is vacuumed by a vacuum pump immediately after the transfer sheet 4 is inserted into the cavity 7 of the mold 5a or 5b and the metal mold 5 is closed, or while the injection-molding resin 10 is being injected from the mold gate 6. In order to carry out vacuuming, a connection port to be connected to the vacuum pump is formed in the internal surface of the cavity 7 of the mold 5a that is airtightly contacted by the transfer sheet 4. By aspirating the air in the cavity from the connection port, the base material sheet 4a is caused to airtightly contact the internal surface of the cavity 7. However, the metal mold 5 is not limited to the above-described mold as long as it is an injection-molding mold for integrally joining the ink receiving layer 2 to the card base 1 at the time of molding the card base 1.

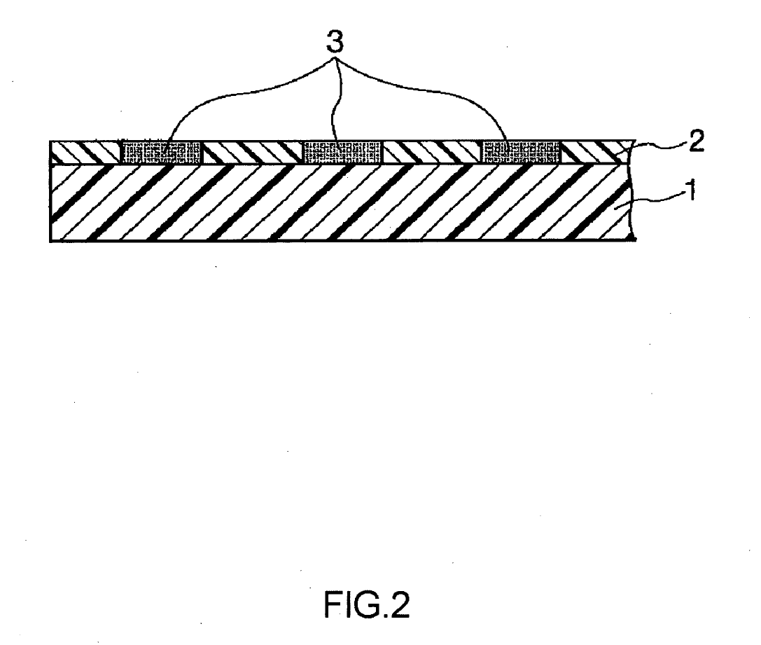

The card manufactured in the above-described manner has the card base 1 joined by the ink receiving layer 2. As shown in FIG. 2, printings are applied to the ink receiving layer 2 with the use of ink 3 to form characters, designs, etc. As such, since according to the present embodiment the printings are applied to the card after the card base 1 is taken out from the cavity 7 of the metal mold 5, characters, designs, etc. can be arbitrarily printed on the print surface of the ink receiving layer 2.

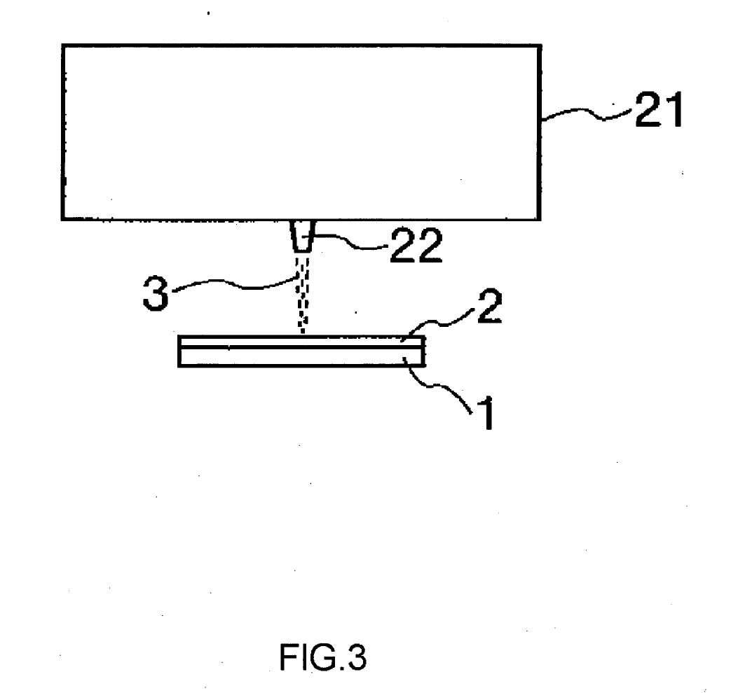

Printing onto the card is executed by, for example, an ink-jet printer. In this case, as shown in FIG. 3, liquid drops of the aqueous ink 3 that are ejected rapidly from a nozzle 22 of the ink-jet printer 21 are infiltrated into the ink receiving layer 2 and fixed thereon as being dried, forming characters and designs, etc. The ink-jet printer 21 may be comprised in a card manufacturing device to be described later. The ink-jet printer 21 is low in running costs as compared with a thermal dye sublimation printer and thermal transfer printer. Therefore, cards with variety in a small lot can be manufactured at a low cost.

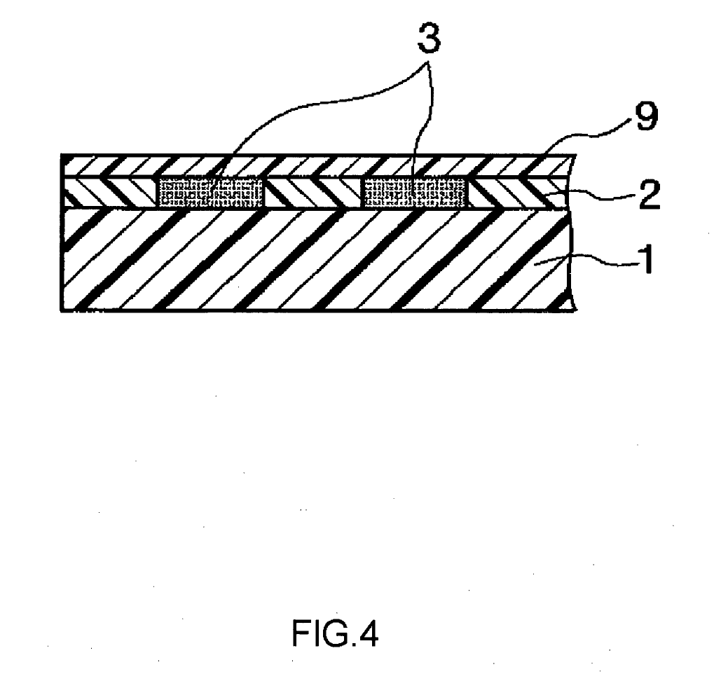

As shown in FIG. 4, the ink receiving layer 2 on the card surface may be covered with a cover layer (protection layer) 9 after printings are applied to the ink receiving layer 2. The cover layer 9 is preferably formed of water-shedding resin, for example, water-shedding room-temperature-curable acrylic resin. Other than this, urethane resin, melanin resin, silicone resin, fluorine resin, etc. are given as the material for the cover layer 9. If the surface of the ink receiving layer 2 is covered with the cover layer 9, the weatherability of the printed portion is improved and the card can therefore be used in a poor use environment.

The cover layer 9 is formed by, for example, after printings are applied to the ink receiving layer 2, coating a room-temperature-curable acrylic resin dissolved in an organic solvent such as ketone, ester, ether, etc. with the use of a coating machine such as a spray unit or the like to cover the ink receiving layer 2 with the acrylic resin, and then curing the acrylic resin.

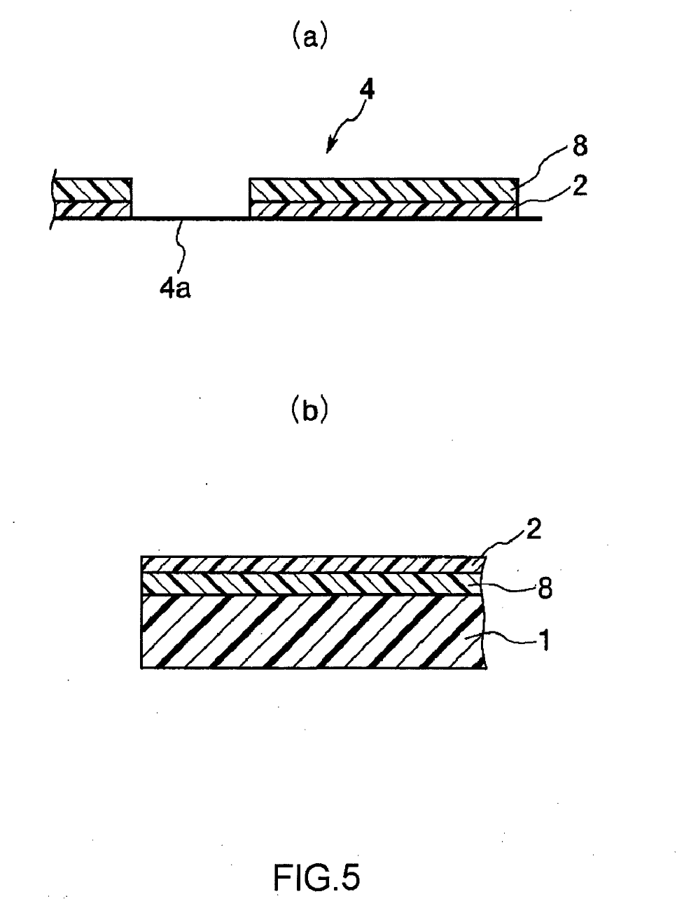

Further, in order to enhance the airtightness of the ink receiving layer 2 to the card base 1, the transfer sheet 4 having an anchor layer 8 pre-formed on the ink receiving layer 2 as shown in FIG. 5(a) may be used. The anchor layer 8 is formed of, for example, adhesive agent such as heat-curable urethane adhesive agent, etc. The anchor layer 8 is formed by coating the paste of an adhesive agent on a surface of the ink receiving layer 2 that is opposite to the base material sheet 4a with the use of a coating machine or the like and then heating and drying the adhesive paste. The material of the anchor layer 8 is not limited to heat-curable adhesive agent, but an adhesive agent that is curable by air seasoning after it is coated may be used.

If the anchor layer 8 is formed on the ink receiving layer 2, the difference in thermal shrinkability at the time of molding or the pressure at the time of molding at the interface between the card base 1 and the ink receiving layer 2 is eased due to the effect of the anchor layer 8, making it possible to improve the airtightness between the card base 1 and the ink receiving layer 2. FIG. 5(b) shows a card to be manufactured with the use of the transfer sheet 4 covered with the anchor layer 8. After printings are applied to the ink receiving layer 2 of the card shown in FIG. 5(b), the ink receiving layer 2 may be covered with the cover layer 9.

The base material sheet 4a is finally separated from the ink receiving layer 2. Therefore, it is preferable that the ink receiving layer 2 be formed of a resin that is relatively poor in compatibility with the base material sheet 4a. A relatively small amount of mold release agent may be blended in the base material sheet 4a.

The ink 3 is not limited to aqueous ink, but a pigment ink may be used. The pigment ink is excellent in lightfastness. Therefore, the unnecessary of covering the print surface of the ink receiving layer 2 with the cover layer 9 becomes less. Further, instead of printing by the ink-jet printer, drawings may be applied to the ink receiving layer 2 by a paint-stick of a plotter, or the user may apply arbitrary handwritten characters or pictures to the ink receiving layer 2 by using a paint-stick.

The present invention is not limited to manufacturing of a simple plastic card, but is applicable to manufacture of an IC (Integrated Circuit) card. In this case, for example, an IC chip is disposed on the base material sheet 4a together with the ink receiving layer 2, and the card base 1 is formed using the resin 10 so as to enclose the IC chip.

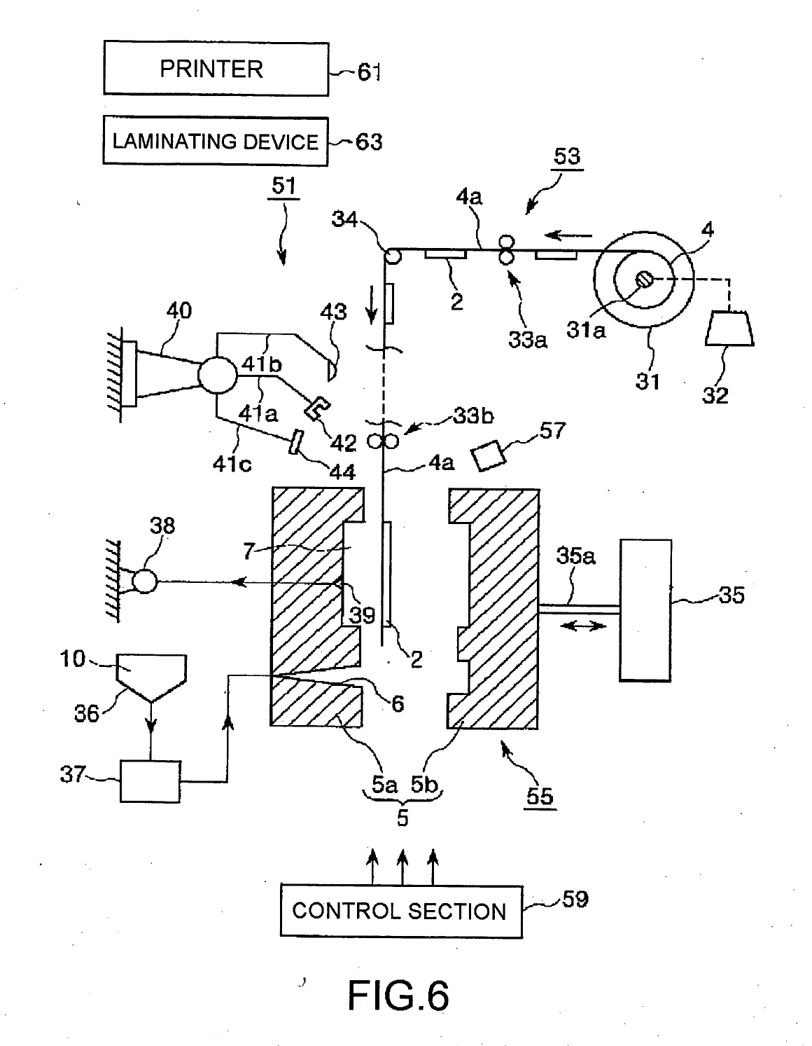

A card manufacturing device 51 for manufacturing a card by implementing he above-described card manufacturing method will now be explained with reference to FIG. 6.

The card manufacturing device 51 comprises a transfer sheet supply section 53 which carries the transfer sheet 4 having the ink receiving layer 2 pre-formed on the base material sheet 4a to the metal mold 5, a molding section 55 which inserts the ink receiving layer 2 into the cavity 7 and molds the card base 1 on the ink receiving layer 2, a control section 59 which controls the entire operation, a printer 61, and a laminating device 63.

As shown in FIG. 6, the transfer sheet supply section 53 comprises a reel 31 having the transfer sheet 4 wound therearound to function as a supply source, a motor 32 for driving a rotation shaft 31a of the reel via a transmission mechanism, a plurality of pairs of rollers 33a and 33b for supporting the transfer sheet 4 being carried, and a carrying direction changing roller 34. In response to the rotation driving by the motor 32, the transfer sheet 4 has its end portion carried to the metal mold 5, as has been explained with reference to FIG. 1(a). It is preferable that at least one of the rollers 33 and 34, particularly, the roller 33b at the farthest downstream be rotated in the carrying direction in synchronization with the rotation driving by the motor 32. The transfer sheet 4 is formed of the base material sheet 4a and a plurality of ink receiving layers 2 formed at regular intervals in the across-the-width direction and across-the-length of the sheet. In order to make it possible to detect that a predetermined amount of transfer sheet 4 is supplied to the metal mold 5, marks for positioning purposes are printed on predetermined positions on the base material sheet 4a.

The molding section 55 comprises the metal mold 5. The metal mold 5 is openable and closable, constituted by the fixed mold 5a and movable mold 5b, and has the mold gate 6 and cavity 7. Plural columns and plural rows of cavities 7 are formed in the internal surface of the molds 5a and 5b in the across-the-width direction and across-the-length correspondingly to the number of ink receiving layers 2 to be accommodated in the metal mold 5. The movable mold 5b is coupled to a hydraulic mold opening/closing mechanism 35 via a coupling rod 35a.

The entrance of the mold gate 6 is connected, through a pipe, to a resin storage tank 36 for storing the injection-molding resin 10 in a powder or pellet state and a resin dissolving tank 37 for thermally dissolving the resin 10 and pumping out the resin by a pump (for example, a syringe pump). The mold gate 6 is connected through the resin supply duct to the cavity 7 in a column at the farthest downstream in the carrying direction of the transfer sheet 4. The cavities 7 adjacent to each other in the across-the-length of the transfer sheet 4 are connected to each other through the resin supply duct, and the cavities 7 adjacent to each other in the across-the-width direction of the transfer sheet 4 may preferably be connected to each other through the resin supply duct. An air aspiration port 39 which is connected to a vacuum pump 38 is formed in the bottom surface of the cavity 7. By aspirating air from the aspiration port 39, the ink receiving layer 2 on the transfer sheet 4 carried from the transfer sheet supply section 53 is inserted into the cavity 7.

A robot 40 and a positioning device 57 are set near the metal mold 5. The robot 40 has arms 41a, 41b, and 41c that are extendable/shrinkable and foldable/bendable, and a gripping member 42, a cutter 43, and a pressing member 44 are attached to the end portions of the arms 41a to 41c respectively. The robot arm 41a having the gripping member 42 grips (or may suck) the base material sheet 4a of the transfer sheet 4, and takes out the transfer sheet 4 from the cavity 7 after the card base 1 is molded. The gripping member 42 and the pressing member 44 peel the base material sheet 4a from the molded card in cooperation with each other. The positioning device 57 has an image pickup device or the like, and determines the position of the transfer sheet 4 with respect to the metal mold 5.

The control section 59 is constituted by a microprocessor or the like, and sends a control signal to each section of the manufacturing device 51 in accordance with an operation program to control the behavior of each section.

The printer 61 is constituted by, for example, the ink-jet printer 21 shown in FIG. 3, and prints arbitrary characters and images on the ink receiving layer 2.

The laminating device 63 forms the cover layer 9 on the ink receiving layer 2.

Next, the working of the card manufacturing device 51 will be explained.

The positioning device 57 detects the position of the transfer sheet 4 with respect to the fixed mold 5a of the metal mold 5, and notifies the control section 59 of positional information. In accordance with the control of the control section 59, the robot 40 grips the base material sheet 4a by the gripping member 42. Further, the control section 59 controls (performs position adjustment of) the position of the ink receiving layer 2 with respect to the cavity 7 by controlling the motor 32 and the robot 40 in accordance with a signal from the positioning device 57.

When positioning is completed, the vacuum pump 38 is actuated to aspirate the ink receiving layer 2 toward the cavity 7 to insert each ink receiving layer 2 into the cavity 7 in a manner that the base material sheet 4a airtightly contacts the bottom surface of the cavity 7.

In the state the vacuum pump 38 is actuated, the mold opening/closing mechanism 35 is actuated to move the movable mold 5b toward the fixed mold 5a to close the metal mold 5.

Then, the pump connected to the resin dissolving tank 37 is driven to inject dissolved resin into the room in the cavity 7 that exists on the side of the ink receiving layer 2 from the mold gate 6 through the resin supply duct. Note that at the time the pump is driven, the injection-molding resin 10 supplied from the resin storage tank 36 to the resin dissolving tank 37 has been dissolved.

After the resin is injected, the injected resin is retained for a predetermined time while a temperature sensor is detecting the temperature of the metal mold 5 to control the circumference of the cavity 7 at a predetermined temperature. As a result, the card base 1 is molded. At the time of the molding, the ink receiving layer 2 of the transfer sheet 4 is joined to the card base 1.

After this, the mold opening/closing mechanism 35 is actuated to move the movable mold 5b to the original position and open the metal mold 5.

Next, the arm 41b is driven to cut the base material sheet 4a in the across-the-width direction between its processed portion and un-processed portion by the cutter 43. After the cutting, the arm 41a is operated to take out the transfer sheet 4 including the card base 1 joined by the ink receiving layer 2 from the cavity 7.

The robot 40 puts the cut transfer sheet 4 on a table in a state where the base material sheet 4a faces upward. Then, the robot 40 peels the base material sheet 4a from the ink receiving layer 2 by gripping the end edge portion of the base material sheet 4a by the gripping member 42, while pressing the portion of the card base 1 onto the table by the pressing member 44. The robot 40 having the gripping member 42 and the pressing member 44 constitutes the peeling section of the card manufacturing device 51.

A sprue formed in the mold gate 6 and resin supply duct is left on the card base 1 from which the base material sheet 4a is peeled. The robot 40 cuts and removes the sprue, or carries out debarring by the cutter 43.

In this way, a card formed of the card base 1 integrated with the ink receiving layer 2 is manufactured.

In the card manufacturing device 51, the mold gate 6 may be connected not to the cavity 7 in the farthest downstream column but to a cavity 7 in the midmost column. Further, the position of the mold gate 6 is arbitrary, and the mold gate 6 may be formed, for example, in the center of the fixed mold 5a. FIG. 6 shows an example where the cavity 7 is formed in both the molds 5a and 5b, but the cavity 7 may be formed only in the fixed mold 5a.

In the operational order for manufacturing the card, the removal of the sprue or deburring may be partially carried out before the peeling of the base material sheet 4a. Specifically, the robot arm 41b is bent (rotated) along the lateral side of each card base 1 on which the sprue in the mold gate 6 and resin supply duct continuous from the mold gate 6 is formed, so that the base material sheet 4a is cut together with the sprue by the cutter 43. Further, it is unnecessary to automate the peeling operation. For example, in the case of a manufacturing device for manufacturing cards in a small lot, the base material sheet 4a may be peeled from the card base 1 manually.

The robot 40 may carry the card base 1 joined by the ink receiving layer 2 to the printer (for example, an ink-jet printer as shown in FIG. 3) 61, and the printer 61 applies arbitrary printings. When printing is completed, the robot 40 takes out the card from the printer 61, and carries it to the laminating device 63. The laminating device 63 covers the surface of the ink receiving layer 2 with the cover layer 9.

The printer 61 and the laminating device 63 may be prepared as devices separate from the card manufacturing device 51.

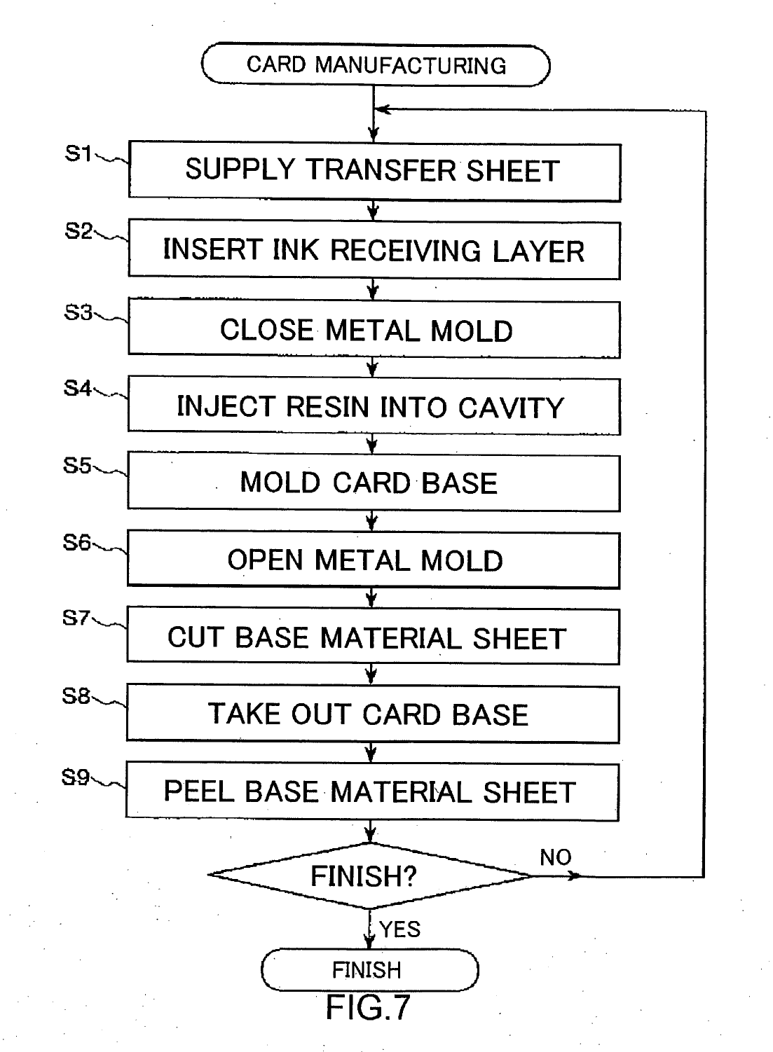

The control process executed by the control section 59 of the card manufacturing device 51 shown in FIG. 6 will be explained with reference to the flowchart shown in FIG. 7.

First, the control section 59 makes the motor 32 rotate to carry and supply the transfer sheet 4 wound around the reel 31 to the metal mold 5 (step S1). When a predetermined amount of transfer sheet 4 is delivered, the control section 59 sends an instruction to the robot 40 to control the gripping member 42 to grip the base material sheet 4a of the transfer sheet 4, and controls the motor 32 and the robot 40 (gripping member 42) in accordance with a position signal from the positioning device 57 to make the position of each ink receiving layer 2 adjusted with respect to its corresponding cavity 7.

Then, the control section 59 actuates the vacuum pump 38 so that each ink receiving layer 2 is inserted into its corresponding cavity 7 (step S2).

When the ink receiving layer 2 is inserted into the cavity 7, the control section 59 sends an instruction to the mold opening/closing mechanism 35 so that the movable mold 5b is moved to close the metal mold 5 (step S3). Next, the control section 59 drives the pump connected to the resin dissolving tank 37 so that the liquid-state injection-molding resin 10 in the resin dissolving tank 37 is injected into the cavity 7 (step S4).

The control section 59 monitors the temperature in the interior of the metal mold 5 by an unillustrated sensor. When the circumference of the cavity 7 is cooled to a redetermined temperature and the injected resin 10 is solidified, the card base 1 is folded (step S5).

After the card base 1 is molded, the control section 59 retreats the movable mold 5b of the mold opening/closing mechanism 35 to the original position to open the metal mold 5 (step S6). Then, the control section 59 sends an instruction to the robot 40 to actuate the cutter 43 to cut the base material sheet 4a (step S7), take out the card base 1 joined by the ink receiving layer 2 from the cavity 7, and place it on the table (step S8).

Then, the control section 59 controls the robot 40 so that the base material sheet 4a is peeled from the ink receiving layer 2 by the gripping member 42 and pressing member 44 (step S9). The control section 59 further cuts the sprue or burr formed on the lateral side of the card base 1 by the cutter 43. In the way described above, a card formed of the ink base 1 integrated with the ink receiving layer 2 is manufactured.

Then, the control section 59 determines whether or not to finish manufacturing cards. When determining not to finish (No), the control section 59 returns to step S1 to repeat the above steps S1 to S9. When determining to finish the manufacturing operation (Yes) in such a case where an aimed number of cards have been manufactured, the control section 59 finishes manufacturing cards.

The control section 59 controls the robot 40, the printer 61, and the laminating device 63 so that printing and forming of the cover layer 9 are applied to the ink receiving layer 2 of the manufactured card.

An IC chip may be disposed together with the ink receiving layer 2 on the transfer sheet 4 to be supplied from the transfer sheet supply section 53, and the molding section 55 may mold the card base 1 with the resin 10 in a manner to enclose the IC chip. Magnetic powder may be added to the resin to be contained in the resin storage tank 36, so that a magnetic card will be manufactured.

This application is based on Japanese Patent Application No. 2003-292828 filed on Aug. 13, 2003. The specification, claims, and drawings of the above Patent Application are incorporated herein by reference in their entirety.

### INDUSTRIAL APPLICABILITY

The card manufactured by the present invention can be utilized for manufacturing a plastic card, a magnetic card, and an IC card such as a cash card, a credit card, a telephone card, a prepaid card, etc., and an identification card such as for personal identification, employee identification, member identification, etc.

1. A method for manufacturing a card comprising:
a step of inserting a transfer sheet (4) constituted by a base material sheet (4a) on which an ink receiving layer (2) is formed into a cavity (7) of a metal mold (5) in a state where a surface of said ink receiving layer (2) faces a mold gate (6) of said metal mold (5);
a step of molding a card base (1) by injecting an injection-molding resin (10) into said cavity (7) in a state where said transfer sheet (4) is disposed in said cavity (7), and at the same time joining said ink receiving layer (2) to said card base (1);
a step of taking out said card base (1) joined by said ink receiving layer (2) from said cavity (7); and
a step of peeling said base material sheet (4a) from said transfer sheet (4) in a manner that said ink receiving layer (2) is left on said card base (1).

2. The method for manufacturing a card according to claim 1, wherein said ink receiving layer (2) is formed of a heat-curable hydrophilic resin.

3. The method for manufacturing a card according to claim 1, characterized in that an anchor layer (8) for enhancing airtightness of said ink receiving layer (2) to said card base (1) is pre-formed on said ink receiving layer (2).

4. The method for manufacturing a card according to claim 1, wherein after said card base (1) is taken out from said cavity (7), printing is applied to said ink receiving layer (2).

5. The method for manufacturing a card according to claim 4, wherein said printing is executed by an ink-jet printer (21).

6. The method for manufacturing a card according to claim 4, comprising a step of covering the surface of said ink receiving layer (2) with a cover layer (9) after printing is applied to said ink receiving layer (2).

7. A card manufacturing device comprising:
a transfer sheet supply section (53) which carries a transfer sheet (4) constituted by a base material sheet (4a) on which an ink receiving layer (2) is formed; and
a molding section (55) which has a cavity (7) into which said ink receiving layer (2) is inserted toward its bottom surface via said base material sheet (4a) and a mold gate (6) from which an injection-molding resin (10) is injected into said cavity (7), and which molds a card base (1) on said ink receiving layer (2) of said transfer sheet (4) carried from said transfer sheet supply section (53), whereby a card formed of said card base (1) integrated with said ink receiving layer (2) is manufactured.

8. The card manufacturing device according to claim 7, comprising a peeling section (40) which peels said base material sheet (4a) from said ink receiving layer (2) integrated with said card base (1).

9. The card manufacturing device according to claim 7, wherein an anchor layer (8) is pre-formed on said ink receiving layer (2).

10. The card manufacturing device according to claim 7, further comprising a printer (61) which applies printing on a surface of said ink receiving layer (2) from which said base material sheet (4a) has been peeled.

11. The card manufacturing device according to claim 10, wherein said printer (61) is an ink-jet printer (21), and ink (3) ejected from said ink-jet printer (21) is aqueous ink.

12. The card manufacturing device according to claim 10, further comprising a laminating device (63) which covers the surface of said ink receiving layer (2) on which printing has been applied with a cover layer (9).
